(19) United States
(12) Patent Application Publication
(10) Pub. No.: US 2018/0260650 A1
(43) Pub. Date: Sep. 13, 2018

(54) IMAGING DEVICE AND IMAGING METHOD

(71) Applicant: Olympus Corporation, Tokyo (JP)

(72) Inventors: Katsuhisa Kawaguchi, Hachioji-shi (JP); Kazuhiro Haneda, Hachioji-shi (JP); Masaomi Tomizawa, Hachioji-shi (JP); Osamu Nonaka, Sagamihara-shi (JP)

(21) Appl. No.: 15/912,536

(22) Filed: Mar. 5, 2018

(30) Foreign Application Priority Data
Mar. 8, 2017 (JP) 2017-043735

(51) Int. Cl. G06K 9/32; G06F 17/30; G06T 7/11; G06F 3/0484

(52) U.S. Cl. CPC G06K 9/3241; G06F 17/30274; G06T 2207/20081; G06F 3/04842; G06F 17/30247; G06T 7/11

(57) ABSTRACT

An imaging device includes an imaging unit, a display controller, a first selector, a second selector, and a record controller. The imaging unit acquires a plurality of items of image data captured by repeatedly imaging an object. The display controller displays images based on the plurality of items of the captured image data on a display after user's imaging operation. The first selector selects first image data among the displayed images in accordance with a user's select operation. The second selector selects second image data among the items of the captured image data based on the first image data. The record controller records the first image data, movie data including the second image data, characteristic information of the first image data, and characteristic information of the movie data in a recording medium.

### CROSS-REFERENCE TO RELATED APPLICATIONS

This application is based upon and claims the benefit of priority from the prior Japanese Patent Application No. 2017-043735, filed Mar. 8, 2017, the entire contents of which are incorporated herein by reference.

### BACKGROUND OF THE INVENTION

### 1. Field of the Invention

The present invention relates to an imaging device and an imaging method.

### 2. Description of the Related Art

There are an enormous number of videos uploaded on the network at video-streaming websites, etc. Various methods have been suggested for a user to find a desired image from the enormous number of videos. For example, Jpn. Pat. Appln. KOKAI Publication No. 2005-167377 discloses a video retrieval apparatus that preferentially presents to a user video data in which there are a number of information resources that have characteristic values of frame images included in video data, for example, video data with high image quality, with a low block noise level, or with a low blurriness level.

### BRIEF SUMMARY OF THE INVENTION

According to an aspect of the invention, there is provided an imaging device comprising: an imaging unit configured to acquire a plurality of items of image data captured by repeatedly imaging an object; a display controller configured to display images based on the plurality of items of the captured image data on a display after user's imaging operation; a first selector configured to select first image data among the displayed images in accordance with a user's select operation; a second selector configured to select second image data among the items of the captured image data based on the first image data; and a record controller configured to record the first image data, movie data including the second image data, characteristic information of the first image data, and characteristic information of the movie data in a recording medium.

According to an aspect of the invention, there is provided an imaging method comprising: acquiring by an imaging unit a plurality of items of image data captured by repeatedly imaging an object; displaying images based on the plurality of items of the captured image data on a display after user's imaging operation; selecting first image data among the displayed images in accordance with a user's select operation; selecting second image data among the items of the captured image data based on the first image data; and recording the first image data, movie data including the second image data, characteristic information of the first image data, and characteristic information of the movie data in a recording medium.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram illustrating the configuration of an imaging device according to one embodiment of the present invention.

FIG. 2A is a flowchart of a basic operation of the imaging device.

FIG. 2B is a flowchart of a basic operation of the imaging device.

FIG. 3A illustrates an example of a list display.

FIG. 3B illustrates an example of a list display.

FIG. 4 is a flowchart of selection processing.

FIG. 5 illustrates an example of a movie file recorded after the selection processing.

### DETAILED DESCRIPTION OF THE INVENTION

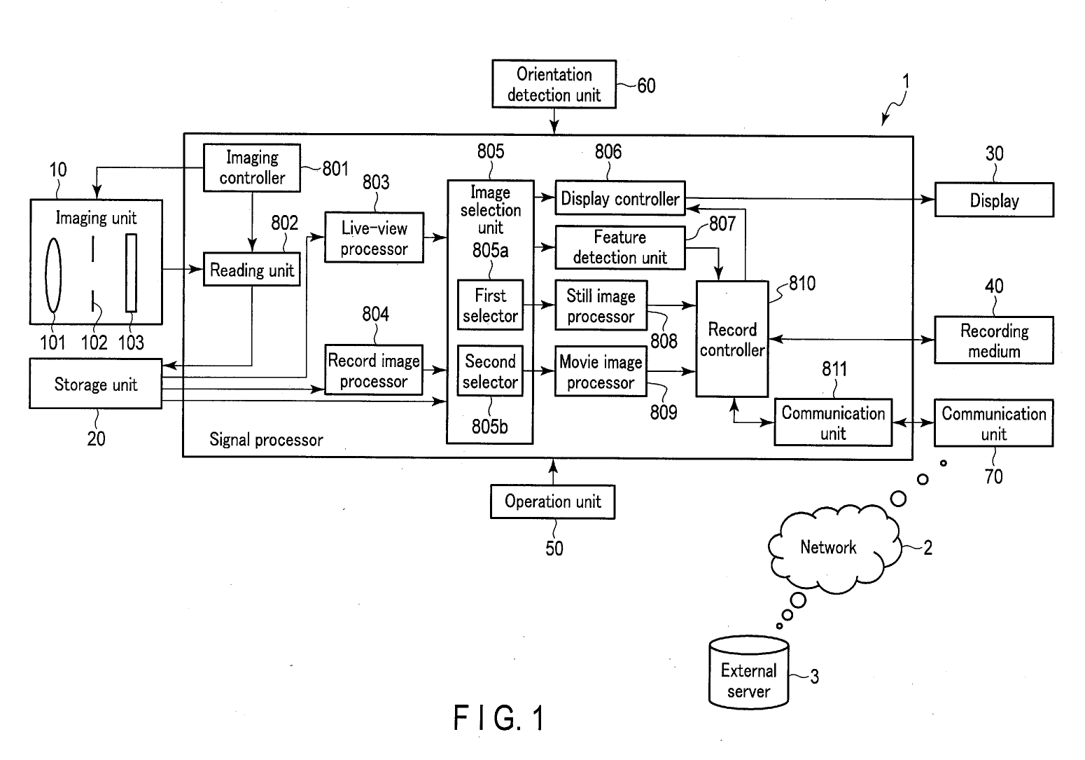

Hereinafter, an embodiment of the present invention will be described with reference to the drawings. FIG. 1 is a block diagram illustrating the configuration of an imaging device according to an embodiment of the present invention. The imaging device 1 shown in FIG. 1 may be various types of devices having an imaging function, such as a digital camera, a smartphone, or a mobile phone with a camera function. The imaging device 1 shown in FIG. 1 includes an imaging unit 10, a storage unit 20, a display 30, a recording medium 40, an operation unit 50, an orientation detection unit 60, a communication unit 70, and a signal processor 80.

The imaging unit 10 includes an imaging lens 101, an aperture 102, and an imaging element 103. The imaging lens 101 allows a luminous flux from an object not shown in the drawings to enter the imaging element 103. The imaging lens 101 may include a focus lens. The imaging lens 101 may also include a zoom lens. The aperture 102 is configured to be variable in size, and to restrict a luminous flux entering the imaging element 103 through the imaging lens 101. The imaging element 103 which includes, for example, a CMOS image sensor or a CCD image sensor, images an object to acquire image data relative to the object. The imaging element 103 may include a phase difference detection pixel in order to detect a distance to the object.

The storage unit 20 which is, for example, a DRAM, temporarily stores image data acquired by the imaging element 103. In addition, the storage unit 20 temporarily stores various processing results at the signal processor 80.

The display 30 which is, for example, a liquid crystal display or an organic EL display, displays various types of images.

The recording medium 40 is constituted of a flash ROM, for example. The recording medium 40 records an image file, etc. generated at the signal processor 80.

The operation unit 50 includes an operation member such as a button, a switch, a dial, etc. The operation unit 50 includes, for example, a release button, a movie button, a setting button, a selection key, and a power button. The release button is an operation member to instruct still imaging. The movie button is an operation member to instruct a start or an end of movie imaging. The setting button is an operation member to display a setting screen of the imaging device 1. The selection key is an operation member to select or determine an item on the setting screen, for example. The power button is an operation member to turn on or off the power of the imaging device 1. The operation unit 50 may have a touch panel. In this case, the touch panel may realize the operations by the aforementioned release button, video button, setting button, selection key, and power button.

The orientation detection unit 60 includes, for example, a three-axes gyro sensor, or an accelerometer, and detects an orientation of the imaging device 1.

The communication unit 70 includes a communication interface through which the imaging device 1 communicates various information with an external device. The communication unit 70 is connected to a network 2 such as the Internet by means of wireless communication, for example, and communicates with an external server 3 which is an external device of the imaging device 1 through the network 2. FIG. 1 illustrates an example where the imaging device 1 communicates with the external server 3. However, the external device with which the imaging device 1 communicates is not limited to a server. For example, the communication unit 70 may be configured to communicate information with various IoT (Internet of Things) devices which are capable of communicating by means of the network 2. The communication by the communication unit 70 may be performed directly with the external device, without going through the network 2. In this case, the direct communication may be performed by wired communication.

The signal processor 80 includes a control circuit such as an ASIC, a CPU, an FPGA, etc., and performs various processing to control the entire operation of the imaging device 1. The signal processor 80 includes an imaging controller 801, a reading unit 802, a live-view processor 803, a record image processor 804, an image selection unit 805, a display controller 806, a characteristic detection unit 807, a still image processor 808, a movie image processor 809, a record controller 810, and a communication unit 811. The function of each block of the signal processor 80 may be implemented by software, or a combination of hardware and software. The function of part of blocks of the signal processor 80 may be provided separately from the signal processor 80.

The imaging controller 801 controls the operation of the imaging unit 10. For example, the imaging controller 801 drives a focus lens of the imaging lens 101 to perform focusing control of the imaging unit 10, or drives a zoom lens to control the viewing angle of the imaging unit 10. The imaging controller 801 performs exposure control of the imaging unit 10 by controlling the opening amount of the aperture 102. The imaging controller 801 also controls an imaging operation of the imaging element 103.

The reading unit 802 reads image data from the imaging element 103 and allows the storage unit 20 to store the image data.

The live-view processor 803 performs an image processing required for live-view display on the image data stored in the storage unit 20. The image processing required for live-view display includes, for example, white balance (WB) correction processing, color conversion processing, gamma conversion processing, noise reduction processing, and expansion/reduction processing. The record image processor 804 performs image processing required for recording to the image data stored in the storage unit 20. The image processing required for recording includes, for example, white balance (WB) correction processing, color conversion processing, gamma conversion processing, noise reduction processing, expansion/reduction processing, and compression processing. The record image processor 804 may be configured to perform processing by a processing parameter different from that used by the live-view processor 803. Of course, the record image processor 804 may be configured to perform processing by the same processing parameter as that used by the live-view processor 803. In addition, the live-view processor 803 and the record image processor 804 may be constituted of one block.

The image selection unit 805 selects image data processed by the live-view processor 803 or image data processed by the record image processor 804, and inputs the selected image data to the display controller 806, the characteristic detection unit 807, the still image processor 808, and the movie image processor 809. The image selection unit 805 includes a first selector 805a and a second selector 805b. The first selector 805a selects image data (first image data) based on a user's selection when performing still imaging. The second selector 805b selects second image data to be recorded as a movie based on the first image data. The details about the first selector 805a and the second selector 805b will be described later.

The display controller 806 performs control to display various images such as an image based on the image data processed by the live-view processor 803 and selected by the image selection unit 805, and an image based on the image data recorded in the recording medium 40 on the display 30.

The characteristic detection unit 807 detects characteristics in the image data processed by the live-view processor 803 and selected by the image selection unit 805, or the image data processed by the record image processor 804 and selected by the image selection unit 805. The characteristics include an object characteristic and a movie characteristic. The object characteristic is a characteristic of an object in image data. The object characteristic includes, for example, a position, a shape, a size of the object, a type of the object, and a type of background of the object. The object characteristic is detected by using a technique such as pattern matching, edge detection, color distribution detection, etc. The movie characteristic is a characteristic of a movie recorded along with the still imaging described later. The movie characteristic includes information such as a time of imaging a representative image in a movie, a moving direction of an object in a movie, a moving speed of an object in a movie, a date of imaging a movie, a place of imaging a movie, a scene of a movie, a type of the imaging device 1, a focal length of the imaging unit 10 when imaging a movie, an aperture, a shutter speed, and user information of the imaging device 1. The details about the information will be described later. The movie characteristic may be detected from information set in the imaging device 1.

The still image processor 808 performs still image compression processing to the image data processed by the record image processor 804 and selected by the image selection unit 805. The still image compression processing is, for example, JPEG compression processing, but is not limited thereto. The movie image processor 809 performs movie compression processing of the image data processed by the record image processor 804 and selected by the image selection unit 805. The movie compression processing is, for example, MPEG compression processing, but is not limited thereto.

The record controller 810 performs recording of image data compressed by the still image processor 808 and image data compressed by the movie image processor 809 to the recording medium 40. For example, the record controller 810 generates a still image file based on the image data compressed by the still image processor 808, and records the generated still image file to the recording medium 40. In addition, the record controller 810 generates a movie file based on the image data compressed by the movie image processor 809, and records the generated movie file to the recording medium 40. The record controller 810 records in the recording medium 40 the object characteristic and the movie characteristic detected by the characteristic detection unit 807 to be associated with the generated file, if required.

The communication unit 811 controls communication through the communication unit 70. For example, the communication unit 811 transmits to the external server 3 the image data recorded in the recording medium 40 or characteristic information associated with the image data. The communication unit 811 receives various information from the external server 3.

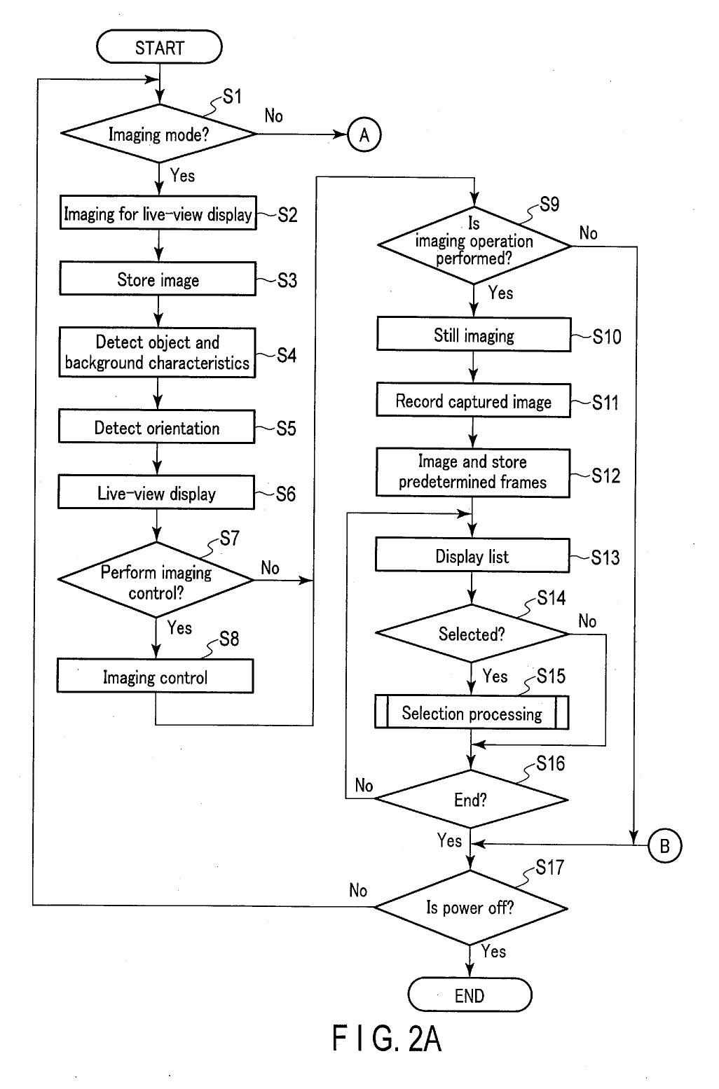

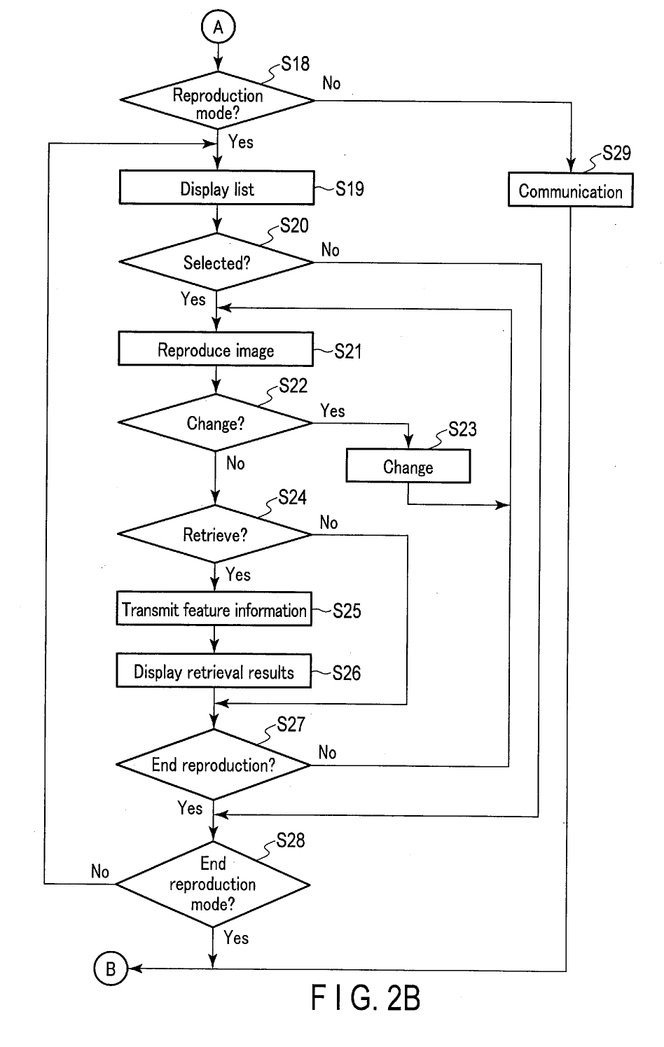

In the following description, the operation of the imaging device 1 according to the present embodiment will be explained. FIG. 2A and FIG. 2B are flowcharts of the basic operation of the imaging device 1. The operations in the flowcharts of FIGS. 2A and 2B are controlled by the signal processor 80.

In step S1, the signal processor 80 determines whether or not a current operation mode of the imaging device 1 is an imaging mode. The operation modes of the imaging device 1 include an imaging mode, a reproduction mode, and a communication mode. The imaging mode is an operation mode to perform recording of a still image or a movie. The reproduction mode is an operation mode to perform reproduction of the image file, etc. recorded in the recording medium 40 on the display 30. The communication mode is a mode to receive various information through communication with the external server 3. The operation mode is set by an operation of the operation unit 50 by a user, for example. If it is determined in step S1 that the current operation mode of the imaging device 1 is the imaging mode, the processing proceeds to step S2. If it is determined in step S1 that the current operation mode of the imaging device 1 is not the imaging mode, the processing proceeds to step S18.

In step S2, the signal processor 80 directs the imaging controller 801 to start an imaging operation for live-view display. For the imaging operation for live-view display, the imaging controller 801 directs the imaging element 103 to execute the imaging operation at a predetermined frame rate.

In step S3, the signal processor 80 directs the reading unit 802 to read image data successively generated by the imaging element 103 and directs the storage unit 20 to store the read image data. The storage unit 20 copies and stores image data acquired by the imaging operation for live-view display. That is, even in the case where the image data acquired by the imaging operation for the live-view display is used in a process subsequent to step S3, the image data stored in the storage unit 20 remains in the storage unit 20. The storage unit 20 may be configured to store copied image data of a predetermined number of frames. In this case, the storage unit 20 successively deletes image data of old frames, and stores image data of new frames. Of course, the image data stored in the storage unit 20 may include image data not used for live-view display. The image data stored in the storage unit 20 may be different from the image for live-view display in the tasks of image processing, image size, etc. Recently, the processing of the imaging element have been accelerated. However, there is no need for a user to check all the images acquired by the imaging element. That is, a movie image can capture an object moving at a speed faster than the human eye can see, but has an enormous amount of information. Accordingly, it is assumed that it matches the user's needs for an image that the user wants to see later to specify the object or the characteristic of movement from images acquired by the user's visual recognition.

In step S4, the signal processor 80 directs the characteristic detection unit 807 to detect characteristics of the image data acquired by the imaging operation for live-view display. Subsequently, the processing proceeds to step S5. For example, the characteristic detection unit 807 detects as characteristics of the image data whether a face is included in image data, a position of the face, and a size of the face by means of a face detection technique using pattern matching, luminance distribution recognition, color distribution recognition, etc. The characteristic detection unit 807 may be configured to perform expression recognition of the detected face, or specify an individual person by matching the detected face with pre-registered facial data. The characteristic detection unit 807 may be configured to specify the type of various objects other than a face as the object of detection. The characteristic detection unit 807 specifies the type of background of the object by using the luminance distribution, color distribution, etc. of the image. The database used for specifying the object or the background may be provided in the characteristic detection unit 807, or in the external server 3, etc. To specify the type of background, the current position of the imaging device 1, results of text recognition, etc. may be used as well. When performing such recognition, various problems may occur depending on a scene. Accordingly, for performing recognition, a technique of artificial intelligence, such as deep learning which uses supervised images may be used as well.

In step S5, the signal processor 80 acquires information of an orientation of the imaging device 1 detected by the orientation detection unit 60.

In step S6, the signal processor 80 performs live-view display by directing the display controller 806 to display an image based on the image data acquired by the imaging operation of the imaging element 103 on the display 30. Specifically, the live-view processor 803 reads image data from the storage unit 20, and performs an image processing required for live-view display to the read image data. The image selection unit 805 outputs the image data for live-view display acquired by the live-view processor 803 to the display controller 806. The display controller 806 drives the display 30 and performs live-view display, based on the input image data.

In step S7, the signal processor 80 directs the imaging controller 801 to determine whether imaging control is performed. The imaging control includes automatic exposure (AE) control, auto focus (AF) control, viewing angle control, etc. performed prior to still imaging. For example, in the case where the imaging device 1 is set to perform either of automatic exposure control and auto focus control, it is determined to perform imaging control. The setting is performed on a setting screen, for example. In the case where an instruction for exposure adjustment, focus adjustment, and viewing angle adjustment is made by the user's operation of the operation unit 50, it is also determined to perform imaging control. In step S7, if it is determined to perform imaging control, the processing proceeds to step S8. If it is determined in step S7 to not perform imaging control, the processing proceeds to step S9.

In step S8, the signal processor 80 directs the imaging controller 801 to perform imaging control. Subsequently, the processing proceeds to step S9. For example, when performing automatic exposure control, the imaging controller 801 calculates an aperture value and a shutter speed required for obtaining a proper exposure for still imaging, based on an object luminance calculated from the image data acquired by the imaging operation for live-view. For example, when performing auto focus control, the imaging controller 801 drives a focus lens by evaluating a contrast value of the object, or drives a focus lens based on the phase difference information calculated from the output of the phase detection pixel. For example, when an instruction for viewing angle adjustment is made, the imaging controller 801 drives a zoom lens in accordance with the user's instruction. The image that the user has checked well is considered as being an image that the user is interested in, and is valuable to the user.

In step S9, the signal processor 80 determines whether or not an imaging operation is performed by the user. The imaging operation is, for example, an operation of the release button by the user. If it is determined in step S9 that the imaging operation is performed by the user, the processing proceeds to step S10. If it is determined in step S9 that the imaging operation is not performed by the user, the processing proceeds to step S17.

In step S10, the signal processor 80 directs the imaging controller 801 to start the imaging operation for still image recording. Subsequently, the processing proceeds to step S11. As the imaging operation in step S11, the imaging controller 801 controls the imaging operation of the imaging element 103 in accordance with the aperture value and the shutter speed set by the automatic exposure control in step S8, for example. The storage unit 20 stores image data acquired by the imaging operation.

In step S11, the signal processor 80 directs the record controller 810 to store the image data acquired by the imaging operation for still image recording to the recording medium 40. Subsequently, the processing proceeds to step S12. Specifically, the record image processor 804 reads image data from the storage unit 20, and performs image processing required for still image recording to the read image data. The image selection unit 805 outputs the image data for recording acquired by the record image processor 804 to the still image processor 808. The still image processor 808 performs still image compression to the input image data. Thereafter, the record controller 810 generates a still image file by adding predetermined header information to the image data subjected to still image compression, and records the generated still image file to the recording medium 40.

In step S12, the signal processor 80 directs the imaging controller 801 to control the imaging element 103 to execute the imaging operation in a predetermined frame rate so that image data of a predetermined number of frames is stored in the storage unit 20.

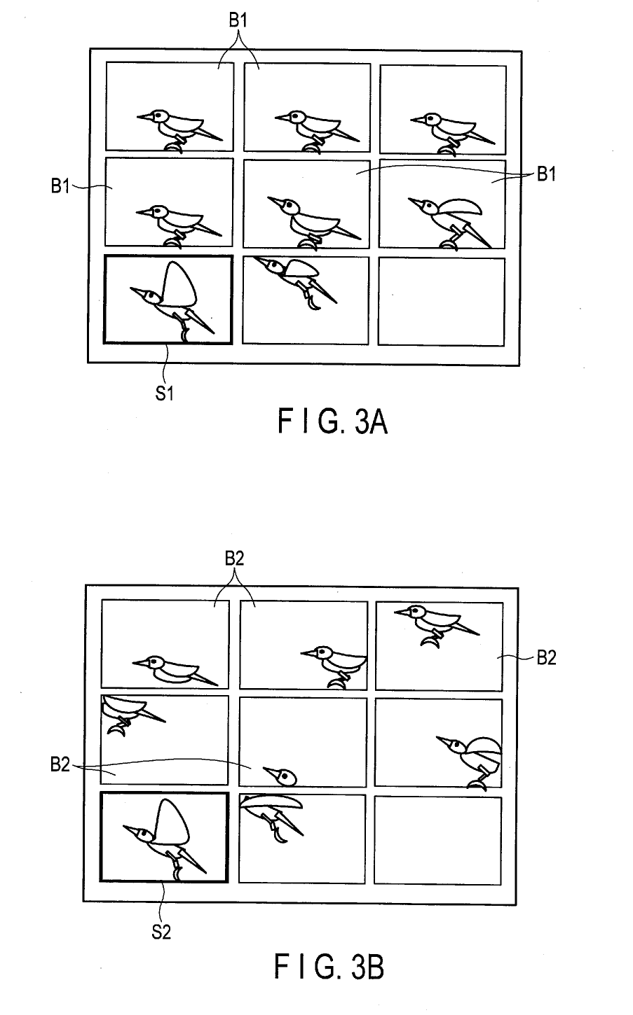

In step S13, the signal processor 80 directs the display controller 806 to display a list of image data stored in the storage unit 20 on the display 30. FIGS. 3A and 3B illustrate an example of a list display. In FIGS. 3A and 3B, the upper left image is the oldest image data captured, and images are arranged toward the right and the bottom in a sequential order of being captured. In FIGS. 3A and 3B, the object is a bird, and a user is assumed to attempt to image a bird at the moment of flying away. FIG. 3A is an example of a list display where the movement of the imaging device 1 by the user follows the bird's movement of flying away. In this case, the position of the bird in the image data in the list display is not substantially changed. On the other hand, FIG. 3B is an example of a list display where the movement of the imaging device 1 by the user does not follow the bird's movement of flying away. In this case, the position of the bird in the image data in the list display is changed momentarily and is not stable. Both the list displays in FIGS. 3A and 3B are acquired by framing of the user. However, FIG. 3A is an example where the user has confirmed the object. Accordingly, the important information of the movie of FIG. 3A may be better to be stored not only for being used at the time of imaging, but also for effective use in the future. For Example, the information of the movie can contain the user's intention or the user's preference. And it will be useful information for the user's movie searching process.

In step S14, the signal processor 80 determines whether or not image data in the list display is selected by the user. If it is determined in step S14 that the image data is selected by the user, the processing proceeds to step S15. If it is determined in step S14 that the image data is not selected by the user, the processing proceeds to step S16. The information as to whether or not the image data is selected by the user is extremely important. Depending on whether or not such kind of selection operation is performed, it is determined whether or not information as to what kind of image the user needs, or information of the user's preference, can be acquired. In particular, movies can record the object that changes momentarily, and accordingly, movies tend to include an enormous amount of information. However, by filtering the movies by the user's preference, the truly important information can be narrowed down from the enormous amount of information. The system in which the user's preference is accumulated and learned may be adopted. In this case, supervised information for learning can be acquired by the images and the user's selection.

In step S15, the signal processor 80 directs the image selection unit 805 to perform selection processing. The selection processing is processing to select image data in accordance with the selection of image data by the user in step S14. The details about the selection processing will be explained later. If image data is selected by the selection processing, the aforementioned characteristics of image data (object characteristics and movie characteristics) are detected. The detected characteristics of the image data are recorded as being associated with the selected image data. Once the selection processing is completed, the processing proceeds to step S16.

In step S16, the signal processor 80 determines whether or not to end the selection of image data. In step S16, it is determined to end the selection of image data in the case where an end button displayed together with the list display is selected by the user, for example. If it is determined in step S16 to not end the selection of image data, the processing returns to step S13. If it is determined in step S16 to end the selection of image data, the processing proceeds to step S17.

In step S17, the signal processor 80 determines whether or not the imaging device 1 is powered off. If it is determined in step S17 that the imaging device 1 is powered off, the process shown in FIGS. 2A and 2B ends. If it is determined in step S17 that the imaging device 1 is not powered off, the processing returns to step S1.

In step S18, when it is determined that the current operation mode of the imaging device 1 is not the imaging mode in step S1, the signal processor 80 determines whether or not the current operation mode of the imaging device 1 is the reproduction mode. If it is determined in step S18 that the current operation mode of the imaging device 1 is the reproduction mode, the processing proceeds to step S19. If it is determined in step S18 that the current operation mode of the imaging device 1 is not the reproduction mode, the processing proceeds to step S29. There may be a case where an image is confirmed in the reproduction mode. In this case, important information can be acquired by the similar processing to step S14.

In step S19, the signal processor 80 directs the display controller 806 to display a list of image files recorded in the recording medium 40 on the display 30. Subsequently, the processing proceeds to step S20.

In step S20, the signal processor 80 determines whether or not an image file is selected by the user. If it is determined in step S20 that an image file is selected by the user, the processing proceeds to step S21. If it is determined in step S20 that an image file is not selected by the user, the processing proceeds to step S28.

In step S21, the signal processor 80 directs the display controller 806 to reproduce the selected image file on the display 30. The movie file recorded after selection processing explained later includes two types of images: a movie and a representative image. Accordingly, the signal processor 80 allows the user to select which of the movie or the representative image is to be reproduced, and reproduces the image file in accordance with the selection.

In step S22, the signal processor 80 determines whether or not to change the image file to be reproduced. In step S22, it is determined to change the image file to be reproduced if an operation to change the image file to be reproduced is performed by the user through the operation unit 50. If it is determined in step S22 to change the image file to be reproduced, the processing proceeds to step S23. If it is determined in step S22 to not change the image file to be reproduced, the processing proceeds to step S24.

In step S23, the signal processor 80 changes the image file to be reproduced in accordance with the operation of the operation unit 50 by the user. Subsequently, the processing returns to step S21. In this case, the changed image file is reproduced. By this kind of user operation, the image that the user frequently reproduces can be defined. Accordingly, this information can of course be effective information for the learning function.

In step S24, the signal processor 80 determines whether or not to perform retrieval using the image data which is being reproduced. In step S24, it is determined that retrieval processing is performed using the image data which is being reproduced if a user operates, through the operation unit 50, a retrieval button displayed on the display 30 while the image data is being reproduced, for example. If it is determined in step S24 to perform retrieval processing, the processing proceeds to step S25. If it is determined in step S24 to not perform retrieval processing, the processing proceeds to step S27.

In step S25, the signal processor 80 directs the communication unit 811 to transmit characteristics of image data that is being reproduced (object characteristics and movie characteristics) to the external server 3. Subsequently, the processing proceeds to step S26. The external server 3 that has received the characteristics of the image data retrieves image data having characteristics similar to the characteristics of the image data being reproduced, and transmits the retrieved image data to the imaging device 1. The image data may be retrieved from another server, etc. through the external server 3. The characteristics of the image data being reproduced are not necessarily to be used for retrieval of other image data. The characteristics of the image data being reproduced may be used for retrieval of information other than the image data, for example. The characteristics of the image data being reproduced may be used for control in various IoT devices.

In step S26, the signal processor 80 directs the display controller 806 to display on the display 30 the retrieval results (for example, image data having similar characteristics) received from the external server 3. For example, image data having similar characteristics is displayed so that the user can further improve imaging skills by using the displayed data as a model image. The model image which has similar characteristics is displayed in consideration not only of information simply indicating that the object is similar, but also of the characteristics of movement of the object, and what kind of representative image is selected by the user. Accordingly, the user can use the model that the user actually intends. If an inappropriate model is displayed, problems such as the user seeing unnecessary information, wasting batteries, or the user missing a chance for imaging, may occur.

In step S27, the signal processor 80 determines whether or not to end reproduction of the image file. In step S27, it is determined to end reproduction of the image file if the user operates the operation unit 50 to end the reproduction of the image file. If it is determined in step S27 to not end the reproduction of the image file, the processing returns to step S21. In this case, the reproduction of the image file is continued. If it is determined in step S27 to end the reproduction of the image file, the processing proceeds to step S28.

In step S28, the signal processor 80 determines whether or not to end processing of the reproduction mode. If it is determined in step S28 to not end the processing of the reproduction mode, the processing returns to step S19. If it is determined in step S28 to end the processing of the reproduction mode, the processing proceeds to step S17.

In step S29, when it is determined that the current operation mode of the imaging device 1 is not the reproduction mode in step S18, the signal processor 80 performs processing of the communication mode. In the communication mode, the signal processor 80 directs the communication unit 811 to transmit an image file designated by the user to an external device, or to receive an image file, etc. from the external device. Once the processing of the communication mode is completed, the processing proceeds to step S17.

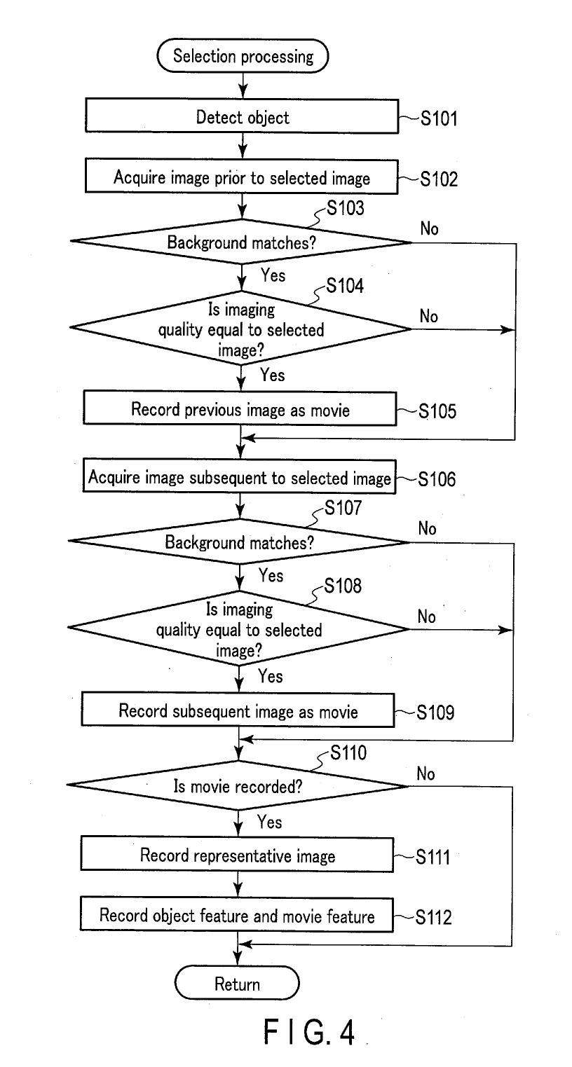

Next, the selection processing will be described. FIG. 4 is a flowchart of the selection processing. It is assumed that the user selects image data S1 shown in FIG. 3A or image data S2 shown in FIG. 3B prior to the selection processing. In accordance with the selection, the first selector 805a of the image selection unit 805 specifies selected image data.

In step S101, the signal processor 80 detects an object in the selected image data. The object is detected based on the characteristics detected by the characteristic detection unit 807. The signal processor 80, for example, detects an object such as an object placed in the center, or a moving object.

In step S102, the signal processor 80 acquires a plurality of items of image data stored in the storage unit 20 prior to the selected image data. The image data read from the storage unit 20 (previous image data) is input to the image selection unit 805.

In step S103, the signal processor 80 directs the second selector 805b to determine whether or not the background substantially matches between the selected image data and the previous image data. Whether or not the background matches is determined based on the difference in the background part (part except the object) between the selected image data and the previous image data, for example. For example, in FIG. 3A, the background of the selected image data S1 and the previous image data B1 is the sky. Accordingly, it is determined that the background matches. Similarly, in FIG. 3B, the background of the selected image data S2 and the previous image data B2 is the sky. Accordingly, it is determined that the background matches. In step S103, a “match” does not indicate a complete match. For example, if there are a predetermined number of frames or more having the background substantially matching each other in the previous image data, it may be determined that the background matches. If it is determined in step S103 that the background matches between the selected image data and the previous image data, the processing proceeds to step S104. If it is determined in step S103 that the background does not match between the selected image data and the previous image data, the processing proceeds to step S106. That is, in this processing, the user's preference based on the user's selection is reflected to infer meaningful data among the enormous amount of image data. FIG. 3A includes sequential images close to the user's preference in terms of the composition, and FIG. 3B does not include such images. Thus, it can be determined that FIG. 3A is closer to the user's preference rather than FIG. 3B. This indicates that effective information in terms of the composition can be obtained based on the user's selection, analysis and inference. The user's action is merely a simple selecting action; however, the technical idea of the present application is to derive various effective information from the selecting action. The effective information is used for determination of the user's preference or retrieval of an image.

In step S104, the signal processor 80 directs the second selector 805b to determine whether or not the imaging quality substantially matches between the selected image data and the previous image data. The imaging quality indicates at least one of a focusing state to the object, an exposure state to the object, or the viewing angle state of the imaging unit 10. In addition, whether or not camera shake occurs may be adopted to the imaging quality. The focusing state is determined by comparing the contrast values between the selected image data and the previous image data, for example. The exposure state is determined by comparing the luminance values between the selected image data and the previous image data. The viewing angle state is determined based on the position and the size of the object, and the orientation of the imaging device 1, for example. For example, in FIG. 3A, all of the focusing state, exposure state, and viewing angle state are substantially equal between the selected image data S1 and the previous image data B1. Accordingly, it is determined that the imaging quality is substantially equal. On the other hand, in FIG. 3B, at least a viewing angle state is different between the selected image data S2 and the previous image data B2, and accordingly, it is determined that the imaging quality is not substantially equal. In step S104, “substantially equal” does not indicate that the values are completely equal to each other. For example, if there are a predetermined number of frames or more having the imaging quality substantially equal to each other in the previous image data, it may be determined that the imaging quality is substantially equal. In addition, if some items of the imaging quality are substantially equal in compared image data, it may be determined that the imaging quality is substantially equal. In this processing, the user's preference based on the user's selection is reflected to infer meaningful data among the enormous amount of image data. In the above examples, the way of confirming appropriateness of the inference is strictly defined. FIG. 3A includes sequential images close to the user's preference in terms of the imaging quality, and FIG. 3B does not include such images. Thus, it can be determined that FIG. 3A is closer to the user's preference rather than FIG. 3B. This indicates that effective information such as the user's preference or the user's satisfaction degree to the entire movie in terms of the imaging quality can be obtained by the user's selection, analysis, and inference. If it is determined in step S104 that the imaging quality is substantially equal between the selected image data and the previous image data, the processing proceeds to step S105. If it is determined in step S104 that the imaging quality is not substantially equal between the selected image data and the previous image data, the processing proceeds to step S106.

In step S105, the signal processor 80 directs the record controller 810 to record the previous image data and the selected image data as second image data in the recording medium 40 in the form of a movie image. At this time, the movie image processor 809 performs movie compression to the previous image data and the selected image data and inputs the compressed data to the record controller 810. The record controller 810 records the previous image data and selected image data subjected to the movie compression to the recording medium 40 in the form of a movie file, for example. The movie file recorded in step S105 will be explained later.

In step S106, the signal processor 80 acquires a plurality of image data items stored subsequent to the selected image data in the storage unit 20. The image data read from the storage unit 20 (subsequent image data) is input to the image selection unit 805.

In step S107, the signal processor 80 directs the second selector 805b to determine whether or not the background substantially matches between the selected image data and the subsequent image data. The determination regarding the background match is performed in a similar manner to that for previous image data. If it is determined in step S107 that the background substantially matches between the selected image data and the subsequent image data, the processing proceeds to step S108. If it is determined in step S107 that the background does not substantially match between the selected image data and the subsequent image data, the processing proceeds to step S110.

In step S108, the signal processor 80 directs the second selector 805b to determine whether or not the imaging quality is substantially equal between the selected image data and the subsequent image data. The determination as to whether the imaging quality is substantially equal is performed in a similar manner to that for the previous image data. If it is determined in step S108 that the imaging quality is substantially equal between the selected image data and the subsequent image data, the processing proceeds to step S109. If it is determined in step S108 that the imaging quality is not substantially equal between the selected image data and the subsequent image data, the processing proceeds to step S110.

In step S109, the signal processor 80 directs the record controller 810 to record the subsequent image data and the selected image data as second image data in the recording medium 40 in the form of a movie image. At this time, the movie image processor 809 performs movie compression to the subsequent image data and the selected image data and inputs the compressed data to the record controller 810. The record controller 810 records the subsequent image data and selected image data subjected to the movie compression to the recording medium 40 in the form of a movie file, for example. If the movie file has already been generated in step S105, the record controller 810 adds the subsequent image data to the generated movie file.

In step S110, the signal processor 80 determines whether or not the movie is recorded. It is determined that the movie is recorded in step S110, if at least one of process of step S105 or step S109 is performed. If it is determined in step S110 that the movie is recorded, the processing proceeds to step S111. If it is determined in step S110 that the movie is not recorded, the processing shown in FIG. 4 ends.

In step S111, the signal processor 80 directs the record controller 810 to add a representative image to the movie file. At this time, the still image processor 808 performs still image compression to the representative image data and inputs the compressed data to the record controller 810. The representative image is an image indicating the characteristics of the previously recorded movie, and includes a selected image (representative image 1) selected by the user, and an image of the movie at a particular timing (for example, the first frame of image (representative image 2)), etc. Once the representative image is recorded, the processing proceeds to step S112.

In step S112, the signal processor 80 directs the characteristic detection unit 807 to detect an object characteristic and a movie characteristic. Once the object characteristic and the movie characteristic are detected, the signal processor 80 adds the detected object characteristic and movie characteristic to the movie file. Thereafter, the processing shown in FIG. 4 ends.

The characteristic detection unit 807 detects as an object characteristic, for example, a position, a size, a shape (edge shape), and a color (color distribution) of the object of the selected image data. The information on the position, size, shape (edge shape), and color (color distribution) of the object may be detected for each frame. In addition, the characteristic detection unit 807 specifies the type of the object and the background. The type is specified by referring to a database to specify the object and the background. As stated above, the database is not necessarily installed in the imaging device 1.

The characteristic detection unit 807 acquires as a movie characteristic the points of time where the representative image 1 and the representative image 2 are captured, for example. The characteristic detection unit 807 detects the moving direction and the moving speed (the moving amount between frames) of the object based on the movement of the object between frames. In addition, the date, place, scene (determined based on the scene mode at the time of still imaging, analysis of background, etc.) of imaging the movie, and the device type of the imaging device 1 are obtained. The characteristic detection unit 807 acquires the focal length, aperture, and shutter speed at the time of imaging the previous image data and the subsequent image data. The characteristic detection unit 807 acquires user information in the case where the user information of the imaging device 1 is registered.

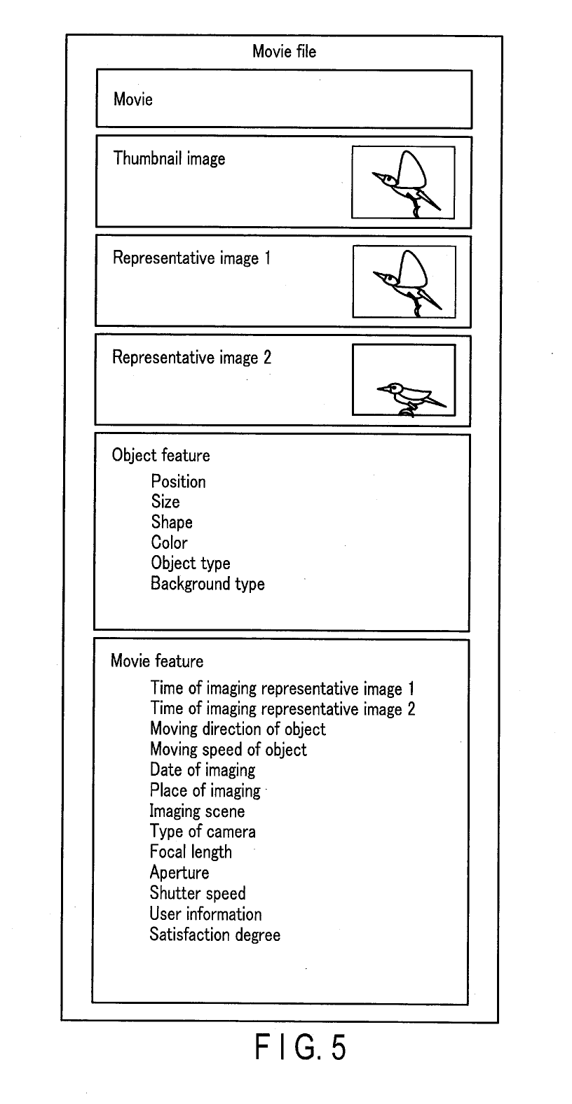

FIG. 5 illustrates an example of a movie file recorded after the selection processing. As shown in FIG. 5, a movie, a thumbnail image, a representative image 1, a representative image 2, an object characteristic, and a movie characteristic are recorded in a movie file.

The movie is movie data in which a plurality of image data items acquired previously and subsequently to a selected image selected by the user are recorded. The image data acquired prior to starting imaging (previous image data) may be image data indicating the process until starting imaging in which the user moves the imaging device 1 to follow the object, or in which the user adjusts the viewing angle. If the image data indicating such a process is recorded as movie data together with the user's selected image data, the movie data may be used as effective information relating to the user's selected image data. However, the previous image in which change is significant between frames as shown in FIG. 3B is not very suitable for watching it as a movie. Accordingly, in the present embodiment, only the image data in which the background and the imaging quality are substantially equal to those of the selected image data is recorded as a movie. For the purpose of recording the process until start imaging, instead of watching the movie, the movie as shown in FIG. 3B may be recorded. Even in the case where there are movies that include frames showing similar images of an object, and the same frame is selected by the user, if both movies are recorded, it is possible to determine that the movie of FIG. 3A is better than the movie of FIG. 3B, for example. The information of success or failure is recorded or learned, for example, so that the information can be used as good supervised information or bad supervised information to improve the accuracy of presenting a model image or to present frequently occurred failure examples. That is, if the ratio of frame numbers in which the user tends to be satisfied with in the composition or the imaging quality to all the frames, or the ratio of difference of digitized characteristic values (or addition of characteristic values or weighted average), etc. are recorded as information of satisfaction degree, the information can be used to realize which movie meets the user's preference, or used as information to determine appropriateness of a movie. That is, if a plurality of image data items of the object that have been repeatedly imaged are acquired, and the user selects first image data among the plurality of image data items, the satisfaction degree of the image data items can be determined based on the selected data. Of course, the image data items may be part of the entire movie. By recording the movie data including the selected first image data and the information on the satisfaction degree in the recording medium, information as to how many of an item (or multiple items if selectable) in which the user's preference is reflected and items previous or subsequent to the selected item are included is clearly recorded, and the information can be effective information for display or retrieval.

A thumbnail image is a scaled-down image of the representative image in the image file used for list display, for example, in the reproduction mode.

The thumbnail image may be a scaled-down image of the representative image 1 or the representative image 2, or a scaled-down image of another image. The thumbnail image which made from the representative image 1 is easy to find out by the user because this representative image is selected with user's intention.

The representative image 1 is a selected image data. The representative image 2 is image data of the first frame, for example. The representative image 1 and the representative image 2 are recorded as a still image. That is, in the present embodiment, a captured image recorded by the user's imaging operation when still imaging is performed, a representative image 1 selected by the user after imaging, and a representative image 2 which is different from the representative image 1 are recorded. It is not necessary to record all of the captured images, representative image 1 and representative image 2. For example, the captured image may be configured to be deleted after recording the movie file.

As stated above, the object characteristic is characteristic information of the object of the selected image data (representative image 1). The movie characteristic is characteristic information of a movie including the image data previous or subsequent to the selected image data. The user's selection of image data may include various information, for example, information indicating that the user prefers the representative image 1 rather than the other image data, and information indicating that a series of images are images in preparation for imaging the representative image 1. In the image data not selected by the user, the focusing state, exposure state, and viewing angle state, etc. are basically confirmed by the user at the time of selecting. Accordingly, if these states are the same, it can be known that the user is not satisfied with another matter. The images indicating the process of the user's imaging are recorded as a movie, and characteristics of the object of the movie and characteristics of the movie are analyzed to use them for retrieval, etc. of other image data so that the user's preference or intention is reflected to the retrieval, etc.

FIG. 5 shows an example of a file format. The movie may be recorded in the form of a movie container file, instead of the file format shown in FIG. 5. The movie shown in FIG. 5 may be recorded in a different file than the representative image. In this case, it is desired that information to associate the movie and the representative image is recorded.

As explained above, according to the present embodiment, the image data is acquired prior to the user's imaging operation, and the user can select image data among the acquired image data. Accordingly, the user can acquire a desired image even when imaging an object that moves fast, etc. In addition, by recording the image data previous and subsequent to the selected image data as a movie, a movie indicating the process of imaging can be recorded, and the value of appreciation of the selected image can be improved. If unprocessed movies are recorded, the user's satisfaction is unknown, and unnecessary information is accumulated. On the other hand, as the present application, storing or utilizing the preference information based on the user's selected image leads to improvement of the user's imaging stills, swiftness, appropriateness, and determination of preference in mutual reference with other users.

In addition, by recording the object characteristic and the movie characteristic, the user's intention in the imaging process can be recorded as information. The image data can be retrieved, etc. by using such information so that the user's intention is reflected to the retrieval, etc. When performing such retrieval, machine learning, etc. may be used for specifying the object, and analyzing, etc. the user's preference or intention. If information on appropriateness is recorded along with a movie as metadata, such a movie can be input to the artificial intelligence as a supervised image to be used for machine learning or deep learning, and an inference model to infer what kind of image is a good image can be created. The appropriateness of a movie is determined based on factors such as viewing angle, focus, exposure, color, composition determined by an orientation of an object, shape of an object, background shape, etc, other than movie characteristics such as changes of an object within a screen. Accordingly, the information on appropriateness of a movie may be information suitable for creating an inference model by deep learning, etc. Some of the patterns of camera shake make a viewer feel nauseous, and accordingly, an inference model used for determining the appropriateness of a movie based on camera shake patterns can be created. Since a movie includes an enormous number of frames, if information to classify selected frames and unselected frames is added to each frame of a movie, a large amount of supervised data can be easily obtained. That is, this invention is suitable for obtaining effective data when creating an inference model to determine the appropriateness of a still image. Furthermore, it is desirable that a computer performs trial and error many times to determine a position of a part of the user's interest (a position of a face, a position of eyes), etc. in each image in order to generalize the position of the part of the user's interest instead of having a human perform such determination. Information relating to such a part of the user's interest may be recorded in an image as metadata. If such metadata is described by natural language, the metadata can be big data utilized by a number of people. On the other hand, such metadata may be described as a state where coding is applied based on particular rules, instead of being described by natural language. That is, if an imaging step by a user's operation, a step of displaying multiple image frames obtained by the imaging step, a step of selecting a particular frame among the multiple frames, and a step of identifying a frame similar to the selected frame as an appropriate image are adopted, a method or a program to obtain supervised data for deep learning to identify a good movie or to select a good still image frame from a movie can be provided. A step of identifying a frame not similar to the selected frame as an inappropriate image may be supplementarily adopted. If a step of designating a good image part is adopted, it is possible to identify a movie in which a user's interest is reflected, or to obtain supervised data for deep learning to perform image processing by applying such a movie when imaging. That is, an imaging device that utilizes an inference model which is a result of such learning, and controls, displays or outputs a guidance can be provided.

In the aforementioned embodiment, a movie is not recorded unless selection of selected image data is performed. On the other hand, a movie file as shown in FIG. 5 may be recorded regardless of whether or not selection of image data is performed. With information indicating that no image is selected, information in that the user is satisfied with the image that the user captured first can be obtained. In the aforementioned embodiment, image data previous and subsequent to the selected image data is recorded as a movie; however, only image data previous to the selected image data may be recorded as a movie, for example.

The present invention has been explained based on the embodiment; however, the present invention is not limited to the embodiment. The present invention may, of course, be modified in various ways without departing from the spirit and scope of the invention. For example, the technique of the present embodiment may be adopted to a security purpose, a security camera, a vehicle-mounted camera, etc. A movie has a characteristic of recording a process or a change until or after a decisive moment, or movement of the object, in addition to recording a decisive moment as a still image. Accordingly, the present invention can be utilized for a purpose of recording a process or a change in medical, scientific, and industrial fields.

The processing described in relation to the above embodiment may be stored in the form of a program executable by the signal processor 80 which is a computer. The programs can be stored in storage mediums of external storage devices, such as a magnetic disk, an optical disk, or a semiconductor memory, and distributed. The signal processor 80 reads the program from a storage medium of an external storage device, and the above processing can be executed by controlling the operations by the read program. The branches or the process of determination shown uniformly as a flowchart may be complicated branches in which a number of variables are processed by artificial intelligence. By combining machine learning or deep learning in which the results of a user's manual operations are accumulated, the process of judgment, determination, and decision can be performed with high precision. Utilizing the artificial intelligence can improve the performance of object characteristic or image determination. That is, the characteristic detection unit 807 may utilize the technique so as to make information of object characteristics and movie characteristics to be more accurate or more specific.

For example, the following invention can be realized in addition to the invention recited in original claims of the present application.

[1] An imaging method comprising:

acquiring a plurality of items of image data captured by repeatedly imaging an object;

selecting first image data among the items of image data in accordance with a user's operation;

determining a satisfaction degree for the captured items of image data based on the first image data; and

recording movie data including the first image data and information on the satisfaction degree in a recording medium.

In the embodiment, a part named as a section or a unit may be structured by a dedicated circuit or a combination of a plurality of general purpose circuits, and may be structured by a combination of a microcomputer operable in accordance with a pre-programmed software, a processor such as a CPU, or a sequencer such as an FPGA. In addition, a design where a part of or total control is performed by an external device can be adopted. In this case, a communication circuit is connected by wiring or wirelessly. Communication may be performed by means of Bluetooth, WiFi, a telephone line, or a USB. A dedicated circuit, a general purpose circuit, or a controller may be integrally structured as an ASIC. A specific mechanical functionality (can be substituted by a robot when a user images while moving) may be structured by various actuators and mobile concatenating mechanisms depending on the need, and may be structured by an actuator operable by a driver circuit. The driver circuit is controlled by a microcomputer or an ASIC in accordance with a specific program. The control may be corrected or adjusted in detail in accordance with information output by various sensors or peripheral circuits.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An imaging device comprising:
an imaging unit configured to acquire a plurality of items of image data captured by repeatedly imaging an object;
a display controller configured to display images based on the plurality of items of the captured image data on a display after user's imaging operation;
a first selector configured to select first image data among the displayed images in accordance with a user's select operation;
a second selector configured to select second image data among the items of the captured image data based on the first image data; and
a record controller configured to record the first image data, movie data including the second image data, characteristic information of the first image data, and characteristic information of the movie data in a recording medium.

2. The imaging device according to claim 1, wherein the second selector selects an item of image data which is substantially equal to the first image data in imaging quality among the items of the captured image data.

3. The imaging device according to claim 2, wherein the imaging quality includes at least one of a focusing state of the imaging unit relative to the object, an exposure state of the imaging unit relative to the object, or a viewing angle state of the imaging unit.

4. The imaging device according to claim 1, wherein the characteristic information of the first image data includes information of the object in the first image data.

5. The imaging device according to claim 1, wherein the information of the object includes at least one of a position, a size, a shape, a color, a type of the object in the first image data, or information on a background of the first image data.

6. The imaging device according to claim 1, wherein the characteristic information of the movie data includes at least one of information on an imaging time of a frame including the object, a moving direction of the object, or a moving speed of the object.

7. An imaging method comprising:
acquiring by an imaging unit a plurality of items of image data captured by repeatedly imaging an object;
displaying images based on the plurality of items of the captured image data on a display after user's imaging operation;
selecting first image data among the displayed images in accordance with a user's select operation;
selecting second image data among the items of the captured image data based on the first image data; and
recording the first image data, movie data including the second image data, characteristic information of the first image data, and characteristic information of the movie data in a recording medium.

8. An imaging device comprising:
an imaging unit configured to acquire a plurality of items of image data captured by repeatedly imaging an object;
a first selector configured to select still image data among the items of image data in accordance with a timing of an imaging operation;
a second selector configured to automatically select movie material data among the items of image data based on the still image data selected by the first selector; and
a record controller configured to record the still image data, movie data including the movie material data, object characteristic information of the still image data, and characteristic information of the movie material data in a recording medium.

9. An imaging device comprising:
an imaging unit configured to acquire a plurality of items of image data captured by repeatedly imaging an object;
a first selector configured to select a first image data group among the items of image data in accordance with a user's operation;
a second selector configured to particular image data among the items of image data based on a reproduction result of the first image data group; and
a record controller configured to record movie data including the particular image data, characteristic information of the particular image data, and characteristic information of the movie data in a recording medium.

10. A method of obtaining supervised data for deep learning, comprising:
imaging;
displaying images of a plurality of frames obtained by the imaging;
selecting a particular frame among the images of the frames; and
identifying a frame similar to the selected frame as an image appropriate for a movie.
